(19) United States
(12) Patent Application Publication
(10) Pub. No.: US 2015/0177632 A1
(43) Pub. Date: Jun. 25, 2015

(54) ELECTROSTATIC IMAGE DEVELOPING TONER

(71) Applicant: Konica Minolta, Inc., Tokyo (JP)

(72) Inventors: Kazumi IMAE, Sagamihara-shi (JP); Tatsuya FUJISAKI, Tokyo (JP); Kouji SUGAMA, Tokyo (JP); Kaori MATSUSHIMA, Tokyo (JP); Junya ONISHI, Tokyo (JP); Aya SHIRAI, Tokyo (JP); Takaki KAWAMURA, Tokyo (JP)

(21) Appl. No.: 14/560,686

(22) Filed: Dec. 4, 2014

(30) Foreign Application Priority Data
Dec. 24, 2013 (JP) 2013-265194

(51) Int. Cl. G03G 9/08; G03G 9/087

(52) U.S. Cl. CPC G03G 9/0825; G03G 9/08711

(57) ABSTRACT

An electrostatic image developing toner includes a toner particle having a core-shell structure including a core portion containing a first polyester resin A, and a shell layer containing a second polyester resin B, the shell layer coating the core portion, wherein the second polyester resin B has at least a meta-phenylene skeleton, and the following relational expression (1) is satisfied: relational expression (1): 0≦a<b, where a represents a content rate (mass %) of a meta-phenylene skeleton in the first polyester resin A, and b represents a content rate (mass %) of the meta-phenylene skeleton in the second polyester resin B.

The entire disclosure of Japanese Patent Application No. 2013-265194 filed on Dec. 24, 2013 including description, claims, drawings, and abstract are incorporated herein by reference in its entirety.

### BACKGROUND OF THE INVENTION

1. Field of the Invention

The present invention relates an electrostatic image developing toner to be used in electrophotographic image formation.

2. Description of the Related Art

In recent years, so as to save more energy in an electrophotographic image forming device, there has been a demand for an electrostatic image developing toner (hereinafter also referred to simply as a “toner”) that can be thermally fixed at lower temperature. In a toner, low-temperature fixing properties can be achieved by lowering the melt temperature and the melt viscosity of the binder resin. However, when the melt temperature and the melt viscosity are lowered, heat-resistant storage properties are degraded. Therefore, there is a need to achieve low-temperature fixing properties and heat-resistant storage properties at the same time.

In response to such a demand, there is a suggested toner that has a core-shell structure having a core portion for achieving low-temperature fixing properties coated with a shell layer for achieving heat-resistant storage properties, and have the respective functions separated.

In a case where compatibility between the core resin forming the core portion and the shell resin forming the shell layer is high, however, the shell layer is likely to become softer, and toner particles adhere to one another. As a result, sufficient heat-resistant storage properties are not achieved. In a case where compatibility between the core resin and the shell resin is too low, the shell layer is detached from the core portion, and the fixed image becomes weaker.

So as to achieve low-temperature fixing properties and heat-resistant storage properties at the same time, JP 2007-114398 A discloses a toner that has a core portion containing a polyester resin with a structure derived from isophthalic acid, and thus controls the compatibility with the shell layer.

With such a toner, excellent low-temperature fixing properties can be achieved by virtue of the sharp melting properties of the polyester resin at the time of heat fixing. Meanwhile, high compatibility (compatibility at the micro level) with the releasing agent contained in the core portion is achieved by virtue of the structure derived from isophthalic acid in the polyester resin contained in the core portion. Accordingly, exposure of the releasing agent through the surfaces of toner particles can be restrained. Also, high compatibility (compatibility at the micro level) can be achieved at the interface between the core portion and the shell layer by virtue of the structure derived from isophthalic acid. Accordingly, high adhesive properties can be achieved between the core portion and the shell layer. At this point, the materials of the core portion and the shell layer are not completely mixed with each other, and are in an immiscible state. However, the shell layer is not detached from the core portion, and excellent heat-resistant storage properties are achieved.

In a case where a polyester resin is used as the binder resin in a toner, however, viscosity during a melting process becomes temporarily lower due to sharp melting properties at the time of heat fixing, and glossiness of a fixed image tends to become higher. So as to make text more recognizable in a text image, for example, the fixed image is expected to be glare-free.

Therefore, there is a demand for a toner that can not only achieve sufficient low-temperature fixing properties and excellent heat-resistant storage properties, but also restrain glossiness of fixed images to low levels. However, it is difficult to satisfy such a demand while using a polyester resin as the binder resin.

### SUMMARY OF THE INVENTION

The present invention has been made in view of the above circumstances, and an object of the present invention is to provide an electrostatic image developing toner with which sufficient low-temperature fixing properties and excellent heat-resistant storage properties are achieved at the same time, and fixed images with reduced glossiness can be formed.

To achieve the abovementioned object, according to an aspect, an electrostatic image developing toner reflecting one aspect of the present invention comprises a toner particle having a core-shell structure that includes a core portion containing a first polyester resin A, and a shell layer containing a second polyester resin B, the shell layer coating the core portion, wherein the second polyester resin B has at least a meta-phenylene skeleton, and the following relational expression (1) is satisfied:

0≦a<b relational expression (1):

where a represents a content rate (mass %) of a meta-phenylene skeleton in the first polyester resin A, and b represents a content rate (mass %) of the meta-phenylene skeleton in the second polyester resin B.

In the electrostatic image developing toner according to the one aspect of the present invention, the first polyester resin A contained in the core portion is preferably a crystalline polyester resin.

In the electrostatic image developing toner according to the one aspect of the present invention, the second polyester resin B contained in the shell layer is preferably an amorphous polyester resin.

In the electrostatic image developing toner according to the one aspect of the present invention, the meta-phenylene skeleton in the first polyester resin A contained in the core portion is preferably derived from isophthalic acid.

In the electrostatic image developing toner according to the one aspect of the present invention, the meta-phenylene skeleton in the second polyester resin B contained in the shell layer is preferably derived from isophthalic acid.

In the electrostatic image developing toner according to the one aspect of the present invention, a difference (b−a) between the content rate a of the meta-phenylene skeleton in the first polyester resin A contained in the core portion and the content rate b of the meta-phenylene skeleton in the second polyester resin B contained in the shell layer is preferably 4 mass % or higher.

In the electrostatic image developing toner according to the one aspect of the present invention, the content rate b of the meta-phenylene skeleton in the second polyester resin B contained in the shell layer is preferably 4 to 16 mass %, and more preferably 8 to 16 mass %.

In the electrostatic image developing toner according to the one aspect of the present invention, the second polyester resin B contained in the shell layer is preferably an amorphous polyester resin formed with a vinyl polymerization segment and a polyester polymerization segment being bound to each other.

In the electrostatic image developing toner according to the one aspect of the present invention, the core portion preferably contains a styrene-acrylic resin as well as the first polyester resin A.

### DESCRIPTION OF THE PREFERRED EMBODIMENTS

Hereinafter, an embodiment of the present invention will be specifically described with reference to the drawings. However, the scope of the invention is not limited to the illustrated examples.

A toner of an embodiment of the present is formed with toner particles each having a core-shell structure formed by coating the surface of a core portion made of a core resin containing a first polyester resin A with a shell layer formed with a shell resin containing a second polyester resin B that has at least a meta-phenylene skeleton.

The content rate a (mass %) of the meta-phenylene skeleton in the first polyester resin A and the content rate b (mass %) of the meta-phenylene skeleton in the second polyester resin B characteristically satisfy the relational expression (1): 0≦a<b.

In the present invention, a toner particle having a core-shell structure may not have a shell layer completely coating the core portion, but may have a shell layer only partially coating the core portion. The shell layer preferably coats 80% or more of the area of the core portion.

Also, part of the shell resin forming the shell layer may form a domain or the like on the core portion.

Since the above described toner is formed with toner particles each having a core-shell structure that includes a core portion containing the first polyester resin A and a shell layer containing the second polyester resin B with a high meta-phenylene skeleton content rate, sufficient low-temperature fixing properties and excellent heat-resistant storage properties are achieved at the same time, and a fixed image with reduced glossiness can be formed.

The reasons for this can be considered as follows. First of all, as the content rate a of the meta-phenylene skeleton in the core portion is zero or is lower than the content rate b of the meta-phenylene skeleton in the shell resin, the toner has sharp melting properties, and quickly melts at the time of heat fixing. Accordingly, sufficient low-temperature fixing properties are achieved.

Meanwhile, as the content rate b of the meta-phenylene skeleton in the shell resin is higher than the content rate a of the meta-phenylene skeleton in the core resin, compatibility between the core portion and the shell layer is restrained to a low level. Further, as the molecules of the main chain forming the shell resin can be partially bent by virtue of the meta-phenylene skeleton contained in the shell resin, the molecules of the shell resin occupy a large space, and the intermolecular distance becomes longer. Therefore, even in a case where the shell layers of toner particles are in contact with one another, the toner is not easily affected by the interaction between molecules at micro portions by virtue of the large occupied space, and fusion between the shell layers of toner particles is restrained. Accordingly, excellent heat-resistant storage properties are supposedly achieved.

Furthermore, as the first polyester resin A partially remains as a domain in the fixed image because the compatibility between the core portion and the shell layer is restrained to a low level, the toner particles after heat fixing have a structure with concavities and convexities, and is not easily affected by the interaction between molecules at micro portions. Also, as a structure with concavities and convexities in conformity with the shapes of the toner particles remains in the fixed image because the compatibility between the shell layers of the toner particles is low, smoothness of the surface of the fixed image is supposedly restricted to a low level, and glossiness of the formed fixed image is also restrained to a low level.

[Core Portion]

The core resin forming the core portion contains the first polyester resin A, and preferably also contains a styrene-acrylic resin in conjunction with the first polyester resin A. A styrene-acrylic resin is likely to have a structure that provides higher elasticity than a polyester resin. With the core portion containing a high-elasticity styrene-acrylic resin, decrease in the elasticity of the entire core resin at the time of heat fixing can be restrained.

The first polyester resin A is either a crystalline polyester resin or an amorphous polyester resin, but a crystalline polyester resin is more preferable as the first polyester resin A.

The first polyester resin A may be a crystalline vinyl-modified polyester resin formed with a vinyl polymerization segment and a polyester polymerization segment that are bound to each other. With such a core portion containing a vinyl-modified polyester resin, excellent compatibility with a styrene-acrylic resin is achieved in a case where the core portion contains the styrene-acrylic resin.

[First Polyester Resin A]

The proportion of the first polyester resin Ain the core resin is preferably 10 to 100 mass %, and more preferably 10 to 30 mass % in the core resin.

As the proportion of the first polyester resin A in the core resin is 10 mass % or higher, sufficient low-temperature fixing properties can be certainly achieved. As the proportion of the first polyester resin A in the core resin is 30 mass % or lower, excellent heat-resistant storage properties are achieved.

The first polyester resin A may have a meta-phenylene skeleton or may not have a meta-phenylene skeleton.

The content rate a of the meta-phenylene skeleton in the first polyester resin A in relation to the content rate b of the meta-phenylene skeleton in the second polyester resin B satisfies the relational expression (1), 0≦a<b, and more specifically, is preferably 0 to 16 mass %.

In the present invention, the content rate of a meta-phenylene skeleton in a polyester resin is the proportion of the mass of the monomer that provides the meta-phenylene skeleton to the entire mass of the resin material used for forming the polyester resin, or the entire mass of a total of the polyprotic carboxylic acid component and the polyhydric alcohol component in a case where the polyester resin is an unmodified polyester resin, or the entire mass of a total of the polyprotic carboxylic acid component and the polyhydric alcohol component to be the polyester polymerization segment, the vinyl monomer to be the vinyl polymerization segment, and the di-reactive monomer for binding these components in a case where the polyester resin is a vinyl-modified polyester resin.

[Crystalline Polyester Resin]

The crystalline polyester resin is formed by condensation polymerization of at least a diol component and a dicarboxylic acid component.

In the present invention, a crystalline polyester resin is a polyester resin that does not show a stepwise change in endothermic energy amount but exhibits a distinct endothermic peak in differential scanning calorimetry (DSC). Specifically, a distinct endothermic peak means a peak having a half value width of 15° C. or narrower when differential scanning calorimetry (DSC) is carried out at a temperature rising rate of 10° C./min.

The diol component for forming the crystalline polyester resin contains an aliphatic diol with a carbon chain formed with a straight chain of 4 to 12 in carbon number, and may contain some other diol as necessary. In the present invention, an aliphatic diol formed with a straight chain (a straight-chain aliphatic diol) has a structure having OH groups bound to both terminals thereof.

The diol component is not limited to one kind, and it is possible to use a mixture of two or more kinds.

Examples of straight-chain aliphatic diols of 4 to 12 in carbon number include 1,4-butanediol, 1,5-pentanediol, 1,6-hexanediol, 1,7-heptanediol, 1,8-octanediol, 1,9-nonanediol, 1,10-decanediol, 1,11-undecanediol, and 1,12-dodecanediol.

The straight-chain aliphatic diol preferably has two OH groups bound to both terminals of the carbon chain.

Examples of other diols include: other straight-chain aliphatic acid diols such as ethylene glycol, 1,3-propanediol, 1,13-tridecanediol, 1,14-tetradecanediol, 1,15-pentadecanediol, 1,18-octadecanediol, and 1,20-eicosanediol; and diols having a double bond such as 2-butene-1,4-diol, 3-hexene-1,6-diol, and 4-octene-1,8-diol.

In a case where the first polyester resin A has a meta-phenylene skeleton, and the meta-phenylene skeleton of the first polyester resin A is introduced from a diol component, the diol component that provides the meta-phenylene skeleton may be meta-xylene glycol.

The dicarboxylic acid component for forming the crystalline polyester resin contains a straight-chain aliphatic dicarboxylic acid with a carbon chain formed with a straight chain of 6 to 14 in carbon number except for the carbons belonging to carboxyl groups, and may contain some other dicarboxylic acid as necessary.

The dicarboxylic acid component is not limited to one kind, and it is possible to use a mixture of two or more kinds.

Examples of straight-chain aliphatic dicarboxylic acids of 6 to 14 in carbon number include adipic acid, suberic acid, azelaic acid, sebacic acid, undecanedioic acid, dodecanedioic acid, 1,13-tridecanedicarboxylic acid, and 1,14-tetradecanedicarboxylic acid.

The straight-chain aliphatic dicarboxylic acid preferably has two COOH groups bound to both terminals of the carbon chain.

Examples of other dicarboxylic acids include other straight-chain aliphatic dicarboxylic acids such as oxalic acid, malonic acid, succinic acid, glutaric acid, adipic acid, pimelic acid, 1,16-hexadecanedicarboxylic acid, and 1,18-octadecanedicarboxylic acid; and lower alkyl esters and acid anhydrides of these materials.

In a case where the first polyester resin A has a meta-phenylene skeleton, and the meta-phenylene skeleton of the first polyester resin A is introduced from a dicarboxylic acid component, the dicarboxylic acid component that provides the meta-phenylene skeleton may be isophthalic acid or 2,7-naphthalenedicarboxylic acid.

In a case where the first polyester resin A has a meta-phenylene skeleton, the meta-phenylene skeleton is preferably derived from isophthalic acid.

The method of manufacturing the crystalline polyester resin is not particularly limited, and the crystalline polyester resin can be manufactured by using a general polyester polymerization method by which a dicarboxylic acid component and a diol component are made to react with each other under the influence of a catalyst, and is preferably manufactured by using direct polycondensation or transesterification depending on the type of the monomer.

Examples of catalysts that can be used in manufacturing the crystalline polyester resin include: titanium catalysts such as titanium tetraethoxide, titanium tetrapropoxide, titanium tetraisopropoxide, and titanium tetrabutoxide; and tin catalysts such as dibutyltin dichloride, dibutyltin oxide, and diphenyltin oxide.

As for the usage ratio between the dicarboxylic acid component and the diol component, the equivalent ratio [OH]/[COOH] between the hydroxyl group [OH] of the diol component and the carboxyl group [COOH] of the dicarboxylic acid component is preferably 1.5/1 to 1/1.5, and more preferably 1.2/1 to 1/1.2.

As for the molecular weight of the crystalline polyester resin measured by gel permeation chromatography (GPC), the weight-average molecular weight (Mw) is preferably 5,000 to 100,000, and more preferably 10,000 to 50,000.

As the weight-average molecular weight (Mw) of the crystalline polyester resin is 5,000 or greater, bleedout of the crystalline polyester resin can be restrained at the time of storage, and accordingly, sufficient heat-resistant storage properties are achieved. As the weight-average molecular weight (Mw) of the crystalline polyester resin is 100,000 or smaller, sufficient low-temperature fixing properties are achieved.

The molecular weight measurement by GPC was carried out in the following manner. With the use of a device “HLC-8220” (manufactured by Tosoh Corporation) and a column “TSKguardcolumn+TSKgelSuperHZM-M triple” (manufactured by Tosoh Corporation), tetrahydrofuran (THF) is applied as a carrier solvent at a flow rate of 0.2 ml/min while the column temperature is maintained at 40° C. The measurement sample (the crystalline polyester resin) is dissolved with the tetrahydrofuran at room temperature for five minutes with the use of an ultrasonic disperser under such dissolution conditions that the density becomes 1 mg/ml. The measurement sample is then processed with a membrane filter of 0.2 μm in pore size to obtain a sample solution, and 10 μL of the sample solution and the carrier solvent are injected into the device. Detection is then performed with the use of a refractive index detector (RI detector). The molecular weight distribution of the measurement sample is calculated by using the calibration curve measured with the use of monodispersed polystyrene standard particulates. The standard polystyrene samples used for calibration curve measurement are manufactured by Pressure Chemical Company and have molecular weights of 6×10², 2.1×10³, 4×10³, 1.75×10⁴, 5.1×10⁴, 1.1×10⁵, 3.9×10⁵, 8.6×10⁵, 2×10⁶, and 4.48×10⁶, and at least ten standard polystyrene samples were measured to create the calibration curve. As the detector, a refractive index detector was used.

The crystalline polyester resin preferably has a melting point of 40 to 90° C., and more preferably 55 to 80° C.

As the melting point of the crystalline polyester resin is 40° C. or higher, the resultant toner has high strength against heat, and sufficient heat-resistant storage properties are achieved. Also, as the melting point of the crystalline polyester resin is 90° C. or lower, the crystalline polyester resin promptly melts at the time of heat fixing, to facilitate fixing of the toner to a transfer member. Thus, sufficient low-temperature fixing properties are achieved.

Specifically, with the use of a differential scanning calorimetry “Diamond DSC” (manufactured by PerkinElmer Inc.), the melting point of the crystalline polyester resin is measured under measurement conditions (temperature rising and cooling conditions) through a first temperature rising process for increasing temperature from 0° C. to 200° C. at a temperature rising rate of 10° C./min, a cooling process for lowering temperature from 200° C. to 0° C. at a cooling rate of 10° C./min, and a second temperature rising process for increasing temperature from 0° C. to 200° C. at a temperature rising rate of 10° C./min. The endothermic peak top temperature derived from the crystalline polyester resin in the first temperature rising process based on the DSC curve obtained through this measurement is set as the melting point. As for the measurement procedures, 3.0 mg of the crystalline polyester resin was sealed in an aluminum pan, and is then set in the sample holder of “Diamond DSC”. An empty aluminum pan is used for reference.

[Styrene-Acrylic Resin]

The styrene-acrylic resin is formed with a styrene-based monomer and a (meth)acrylate-based monomer.

Examples of styrene-based monomers include styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, 3,4-dichlorostyrene, and derivatives of these materials.

Examples of (meth) acrylate-based monomers include methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, β-hydroxyethyl acrylate, γ-aminopropyl acrylate, stearyl methacrylate, dimethylaminoethyl methacrylate, and diethylaminoethyl methacrylate.

It is possible to use one of these materials or a combination of two or more of these materials.

As the polymerizable monomer for forming the styrene-acrylic resin, the above described styrene-based monomer and (meth)acrylate-based monomer can be used in conjunction with a monomer containing any of the vinyl groups listed below (hereinafter referred to as a “vinyl monomer”).

### —Olefins

Ethylene, propylene, isobutylene, and the like

—Vinyl esters

Vinyl propionate, vinyl acetate, vinyl benzoate, and the like

—Vinyl ethers

Vinylmethylether, vinylethylether, and the like

—Vinyl ketones

Vinylmethylketone, vinylethylketone, vinylhexylketone, and the like

—N-vinyl compounds

N-vinylcarbazole, N-vinylindole, N-vinylpyrrolidone, and the like

### —Others

Vinyl compounds such as vinylnaphthalene and vinylpyridine; derivatives of acrylic acids and methacrylic acids such as acrylonitrile, methacrylonitrile, and acrylamide; and the like

As the polymerizable monomer for forming the styrene-acrylic resin, the above described styrene-based monomer and (meth)acrylate-based monomer can be used in conjunction with a material containing any of the ionic dissociable groups such carboxy groups and phosphate groups listed below.

### —Vinyl Monomers Containing a Carboxy Group

(Meth)acrylates such as acrylic acid, methacrylic acid, α-ethyl acrylate, and crotonic acid; α-alkyl derivatives and β-alkyl derivatives; unsaturated dicarboxylic acids such as fumaric acid, maleic acid, citraconic acid, and itaconic acid; unsaturated dicarboxylic acid monoester derivatives such as succinic acid monoacryloyloxyethyl ester, succinic acid monoacryloyloxyethylene ester, phthalic acid monoacryloyloxyethyl ester, and phthalic acid monomethacryloyloxyethyl ester; and others

### —Vinyl Monomers Containing a Phosphate Group

Acid Phosphoxyethyl Methacrylate and Others

As the polymerizable monomer for forming the styrene-acrylic resin, the above described styrene-based monomer and (meth)acrylate-based monomer can be used in conjunction with any of the multifunctional vinyls listed below.

### —Multifunctional Vinyls

Ethyleneglycol dimethacrylate, ethyleneglycol diacrylate, diethyleneglycol dimethacrylate, diethyleneglycol diacrylate, triethyleneglycol dimethacrylate, triethyleneglycol diacrylate, neopentylglycol dimethacrylate, neopentylglycol diacrylate, and the like.

As for the molecular weight of the styrene-acrylic resin measured by gel permeation chromatography (GPC), the weight-average molecular weight (Mw) is preferably 20,000 to 60,000.

As the weight-average molecular weight (Mw) of the styrene-acrylic resin is 20,000 or greater, sufficient heat-resistant storage properties are achieved. As the weight-average molecular weight (Mw) of the styrene-acrylic resin is 60,000 or smaller, sufficient low-temperature fixing properties are achieved.

The measurement of the molecular weight of the styrene-acrylic resin by GPC is carried out in the same manner as described above, except that styrene-acrylic resins are used as measurement samples.

The glass transition point of the styrene-acrylic resin is preferably 20 to 40° C.

As the glass transition point of the styrene-acrylic resin is 20° C. or higher, the resultant toner has high strength against heat, and sufficient heat-resistant storage properties are achieved. As the glass transition point of the styrene-acrylic resin is 40° C. or lower, sufficient low-temperature fixing properties are achieved.

Here, the glass transition point of the styrene-acrylic resin is a value measured by a method (DSC method) specified in ASTM (American Society for Testing Materials) D3418-82 with the use of styrene-acrylic resins as measurement samples.

[Shell Layer]

The shell resin forming the shell layer contains the second polyester resin B having a meta-phenylene skeleton. This second polyester resin B is preferably an amorphous polyester resin, or more particularly, an amorphous vinyl-modified polyester resin formed with a vinyl polymerization segment and a polyester polymerization segment that are bound to each other.

[Second Polyester Resin B]

The proportion of the second polyester resin B in the shell resin is preferably 70 to 100 mass %, and more preferably 90 to 100 mass % in the shell resin.

As the proportion of the second polyester resin B in the shell resin is equal to or higher than 70 mass %, the effect to restrain glossiness of the resultant fixed image is sufficiently achieved.

The content rate b of the meta-phenylene skeleton in the second polyester resin B in relation to the content rate a of the meta-phenylene skeleton in the first polyester resin A satisfies a<b. Specifically, a difference (b−a) between the content rate a of the meta-phenylene skeleton in the first polyester resin A and the content rate b of the meta-phenylene skeleton in the second polyester resin B is preferably 4 mass % or greater.

As the content rate b of the meta-phenylene skeleton in the second polyester resin B is higher than the content rate a of the meta-phenylene skeleton in the first polyester resin A, compatibility between the core portion and the shell layer can be certainly restrained to a low level, and the effect to restrain heat-resistant storage properties and glossiness of a fixed image can be certainly achieved.

The content rate b of the meta-phenylene skeleton in the second polyester resin B is preferably 4 to 16 mass %, and more preferably 8 to 16 mass %.

As the content rate b of the meta-phenylene skeleton in the second polyester resin B is equal to or higher than 4 mass %, the effect to restrain glossiness of the resultant fixed image is sufficiently achieved. Meanwhile, as the content rate b of the meta-phenylene skeleton in the second polyester resin B is equal to or lower than 16 mass %, fusion between the shell layers can be prevented while adhesive properties between the core portion and the shell layer are maintained. Thus, excellent heat-resistant storage properties can be achieved.

[Amorphous Polyester Resin]

In the present invention, an amorphous polyester resin is a polyester resin that is formed by condensation polymerization of at least a polyhydric alcohol component and a polyprotic carboxylic acid component, and does not have any distinct endothermic peak recognized in differential scanning calorimetry (DSC).

The polyprotic carboxylic acid component for forming the amorphous polyester resin may be a polyprotic carboxylic acid, or an alkyl ester, an acid anhydride, or an acid chloride thereof. The polyhydric alcohol component for forming the amorphous polyester resin may be a polyhydric alcohol, or an ester compound or a hydroxycarboxylic acid thereof.

Examples of polyhydric alcohols include: dihydric alcohols such as ethylene glycol, propylene glycol, butanediol, diethylene glycol, hexanediol, cyclohexanediol, octanediol, decanediol, dodecanediol, an ethylene oxide adduct of bisphenol A, and a propylene oxide adduct of bisphenol A; and tri- or higher-valent polyols such as glycerin, pentaerythritol, hexamethylolmelamine, hexaethylolmelamine, tetramethylolbenzoguanamine, and tetraethylolbenzoguanamine.

In a case where the meta-phenylene skeleton of the second polyester resin B is introduced from a polyhydric alcohol component, meta-xylene glycol can be used as the polyhydric alcohol component that provides the meta-phenylene skeleton.

Examples of polyprotic carboxylic acids include: diprotic carboxylic acids such as oxalic acid, succinic acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycollic acid, cyclohexane-3,5-diene-1,2-dicarboxylic acid, malic acid, citric acid, hexahydroterephthalic acid, malonic acid, pimelic acid, tartaric acid, mucic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediglycollic acid, p-phenylenediglycollic acid, o-phenylenediglycollic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and dodecenylsuccinic acid; and di- or higher-valent carboxylic acids such as trimellitic acid, pyromellitic acid, naphthalenetricarboxylic acid, naphthalenetetracarboxylic acid, pyrenetricarboxylic acid, and pyrenetetracarboxylic acid.

In a case where the meta-phenylene skeleton of the second polyester resin B is introduced from a polyprotic carboxylic acid component, isophthalic acid can be used as the polyprotic carboxylic acid component that provides the meta-phenylene skeleton.

As the material that provides the meta-phenylene skeleton of the second polyester resin B, isophthalic acid, which is a carboxylic acid, is more suitable than meta-xylene glycol, which is an alcohol.

The method of manufacturing the amorphous polyester resin is not particularly limited, but the amorphous polyester resin can be manufactured by the same manufacturing method as the above described method of manufacturing the crystalline polyester resin.

As for the molecular weight of the amorphous polyester resin measured by gel permeation chromatography (GPC), the weight-average molecular weight (Mw) is preferably 5,000 to 100,000, and more preferably 5,000 to 50,000.

As the weight-average molecular weight (Mw) of the amorphous polyester resin is 5,000 or greater, compatibility is not formed between the amorphous polyester resin and the crystalline polyester resin forming the core portion at the time of manufacturing and at the time of storage, and accordingly, sufficient heat-resistant storage properties are achieved. As the weight-average molecular weight (Mw) of the amorphous polyester resin is 100,000 or smaller, sufficient low-temperature fixing properties are achieved.

The measurement of the molecular weight of the amorphous polyester resin by GPC is carried out in the same manner as described above, except that amorphous polyester resins are used as measurement samples.

The glass transition point of the amorphous polyester resin is preferably 40 to 90° C., and more preferably 45 to 85° C.

As the glass transition point of the amorphous polyester resin is 40° C. or higher, the resultant toner has high strength against heat, and sufficient heat-resistant storage properties are achieved. Also, as the glass transition point of the amorphous polyester resin is 90° C. or lower, sufficient low-temperature fixing properties are achieved.

The glass transition point of the amorphous polyester resin is a value measured in the same manner as described above, except that amorphous polyester resins are used as measurement samples.

[Vinyl-Modified Polyester Resin]

The vinyl-modified polyester resin is formed with a vinyl polymerization segment and a polyester polymerization segment that are bound to each other, and the vinyl polymerization segment may be bound as a branched chain in the chain of the polyester polymerization segment, or may be bound in such a manner as to form a straight chain. In a case where the vinyl polymerization segment forms a straight chain, the vinyl polymerization segment may form an intermediate portion or a terminal of the straight chain. However, in the case of a vinyl-modified polyester resin having a vinyl polymerization segment bound to a terminal of a polyester polymerization segment, it is easier to form respective domains of the polyester polymerization segment and the vinyl polymerization segment.

In the present invention, the content rate of the polyester polymerization segment in a vinyl-modified polyester resin is 50 mass % or higher.

(Vinyl Polymerization Segment)

The vinyl polymerization segment is formed with a vinyl monomer, can be a styrene polymer, an acrylic polymer, a styrene-acrylic copolymer, or the like, and is preferably a styrene-acrylic copolymer.

Specific examples of vinyl monomers include the above described examples of monomers for forming the styrene-acrylic resin.

(Polyester Polymerization Segment)

The polyester polymerization segment is an amorphous material formed with a polyprotic carboxylic acid component or a polyhydric alcohol component, and specifically, is a material that does not exhibit any distinct endothermic peak in differential scanning calorimetry (DSC). Specific examples of monomers (polyprotic carboxylic acid components and polyhydric alcohol components) for forming the polyester polymerization segment include the above described examples of monomers for forming the amorphous polyester resin.

The proportion of the vinyl polymerization segment in the vinyl-modified polyester resin is preferably 5 to 30 mass %, and more preferably 5 to 20 mass %.

Specifically, the content rate of the vinyl polymerization segment is the proportion of the mass of the vinyl monomer to the entire mass of the resin material used for forming the vinyl-modified polyester resin, or the entire mass of a total of the polyprotic carboxylic acid component and the polyhydric alcohol component to be the polyester polymerization segment, the vinyl monomer to be the vinyl polymerization segment, and the di-reactive monomer for binding these components.

As the content rate of the vinyl polymerization segment is 5 mass % or higher, a highly-elastic component can be sufficiently obtained at the time of the heat fixing, and excellent high-temperature-resistant offset properties are achieved. Meanwhile, as the content rate of the vinyl polymerization segment is 30 mass % or lower, the amount of the polyester polymerization segment to contribute to low-temperature fixing properties can be secured, and sufficient low-temperature fixing properties are certainly achieved.

The weight-average molecular weight (Mw) of the vinyl-modified polyester resin calculated from the molecular weight distribution measured by gel permeation chromatography (GPC) is preferably 10,000 to 100,000.

As the weight-average molecular weight (Mw) of the vinyl-modified polyester resin is 10,000 or greater, excessive glossiness of a resultant image can be certainly prevented while low-temperature fixing properties are maintained. Also, as the weight-average molecular weight (Mw) is 100,000 or smaller, degradation of low-temperature fixing properties can be certainly prevented while heat-resistant storage properties are maintained.

The measurement of the molecular weight of the vinyl-modified polyester resin by GPC is carried out in the same manner as described above, except that vinyl-modified polyester resins are used as measurement samples.

The glass transition point of the vinyl-modified polyester resin is preferably 50 to 75° C.

As the glass transition point of the vinyl-modified polyester resin is 50° C. or higher, the resultant toner has high strength against heat, and sufficient heat-resistant storage properties are achieved. Also, as the glass transition point is 75° C. or lower, sufficient low-temperature fixing properties are achieved.

The glass transition point of the vinyl-modified polyester resin is a value measured in the same manner as described above, except that vinyl-modified polyester resins are used as measurement samples.

[Method of Manufacturing the Vinyl-Modified Polyester Resin]

The vinyl-modified polyester resin can be manufactured by binding the polyester polymerization segment and the vinyl polymerization segment via a di-reactive monomer. Specifically, a polyprotic carboxylic acid and a polyhydric alcohol are prepared before, during, or after the process of addition polymerization of a vinyl monomer, and a polycondensation reaction is caused between the polyprotic carboxylic acid and the polyhydric alcohol, to form the vinyl-modified polyester resin.

More specifically, an existing general scheme can be used. The three methods described below are typical examples of such schemes.

(1) A method including: causing an addition polymerization reaction of the vinyl monomer for forming the vinyl polymerization segment; causing a polycondensation reaction between the polyprotic carboxylic acid and the polyhydric alcohol for forming the polyester polymerization segment; and adding a tri- or higher-valent vinyl monomer that serves as a crosslinking agent as necessary to the reaction system, to further facilitate the polycondensation reaction.
(2) A method including: causing a polycondensation reaction between the polyprotic carboxylic acid and the polyhydric alcohol for forming the polyester polymerization segment; causing an addition polymerization reaction of the vinyl monomer for forming the vinyl polymerization segment; and adding a tri- or higher-valent vinyl monomer that serves as a crosslinking agent as necessary to the reaction system, to further facilitate the polycondensation reaction at a temperature suited for the polycondensation reaction.
(3) A method including: causing, in parallel, an addition polymerization reaction of the vinyl monomer for forming the vinyl polymerization segment and a polycondensation reaction between the polyprotic carboxylic acid and the polyhydric alcohol for forming the polyester polymerization segment; and, after the end of the addition polymerization reaction, adding a tri- or higher-valent vinyl monomer that serves as a crosslinking agent as necessary to the reaction system, to further facilitate the polycondensation reaction at a temperature suited for the polycondensation reaction.

The di-reactive monomer is added at the same time as the addition of the polyprotic carboxylic acid and the polyhydric alcohol, and/or the vinyl monomer.

The di-reactive monomer is a compound that contains, in a molecule, at least one functional group selected from the group consisting of a hydroxyl group, a carboxy group, an epoxy group, a primary amino group, and a secondary amino group, or preferably a hydroxyl group and/or a carboxy group, or more preferably, a carboxy group and an ethylenic unsaturated bond. That is, the di-reactive monomer is preferably a vinyl carboxylic acid. Specific examples of di-reactive monomers include acrylic acid, methacrylic acid, fumaric acid, and maleic acid, and may further include hydroxyalkyl (1 to 3 in carbon number) esters of these materials. However, from the viewpoint of reactivity, it is preferable to use acrylic acid, methacrylic acid, or fumaric acid.

As the di-reactive monomer, a monovalent vinyl carboxylic acid is preferable to a polyvalent vinyl carboxylic acid, so as to achieve high toner durability. This is supposedly because a monovalent vinyl carboxylic acid has high reactivity to a vinyl monomer, and is easily hybridized. In a case where a dicarboxylic acid such as fumaric acid is used as the di-reactive monomer, however, the durability of the toner is lower. This is supposedly because a dicarboxylic acid has low reactivity to a vinyl monomer, and is not easily hybridized but forms a domain structure.

So as to improve low-temperature fixing properties, high-temperature-resistant offset properties, and durability, the amount of the di-reactive monomer relative to a total of 100 parts by mass of the vinyl monomer is preferably 1 to 10 parts by mass, and more preferably 4 to 8 parts by mass. Also, the amount of the di-reactive monomer relative to a total of 100 parts by mass of the polyprotic carboxylic acid and the polyhydric alcohol is preferably 0.3 to 8 parts by mass, and more preferably 0.5 to 5 parts by mass.

The addition polymerization reaction can be caused by a general method in the presence of a radical polymerization initiator, a crosslinking agent, or the like, or in an organic solvent, or in the absence of solvent. The temperature for the addition polymerization reaction is preferably 110 to 200° C., and more preferably 140 to 180° C. Examples of radical polymerization initiators include dialkyl peroxide, dibutyl peroxide, butylperoxi-2-ethylhexyl monocarboxylic acid. It is possible to use one of these example materials, or a combination of two or more of these example materials.

The polycondensation reaction can be caused in an inert gas atmosphere at a temperature of 180 to 250° C., for example. It is preferable to cause the polycondensation reaction in the presence of an esterification catalyst, a polymerization inhibitor, or the like. Examples of esterification catalysts include dibutyltin oxide, titanium compounds, tin (II) compounds not having Sn—C bonds such as tin octylate. It is possible to use one of these example materials, or a combination of two or more of these example materials.

[Ratio Between the Core Resin and the Shell Resin]

The content rate of the shell resin in the binder resin formed with the core resin and the shell resin of toner particle is preferably 5 to 50 mass %, and more preferably 10 to 40 mass %.

As the content rate of the shell resin in the binder resin is 50 mass % or lower, sufficient low-temperature fixing properties can be achieved by virtue of the first polyester resin A forming the core portion. Meanwhile, as the content rate of the shell resin in the binder resin is 5 mass % or higher, excellent heat-resistant storage properties are certainly achieved.

[Structure of a Toner Particle]

A toner particle according to this embodiment of the present invention may contain not only the resins (the binder resin) forming the core portion and the shell layer, but also internal additives such as a colorant, a releasing agent, and a charge control agent, where necessary.

The colorant, the releasing agent, and the charge control agent may be contained in the core portion, or in the shell layer, or in both the core portion and the shell layer. However, the colorant and the releasing agent are preferably contained in the core portion.

[Colorant]

The colorant may be any of the widely known dyes and pigments.

The colorant for obtaining a black toner may be any of various known colorants such as carbon blacks (furnace black and channel black, for example), magnetic substances (magnetite and ferrite, for example), dyes, and inorganic pigments containing nonmagnetic iron oxide.

The colorant for obtaining a color toner may be any of known colorants such as dyes and organic pigments. Specific examples of the organic pigments include: C.I. Pigment Red 5, 48:1, 48:2, 48:3, 53:1, 57:1, 81:4, 122, 139, 144, 149, 166, 177, 178, 222, 238, 269; C.I. Pigment Yellow 14, 17, 74, 93, 94, 138, 155, 180, 185; C.I. Pigment Orange 31, 43; and C.I. Pigment Blue 15:3, 60, 76. Specific examples of the dyes include: C.I. Solvent Red 1, 49, 52, 58, 68, 11, 122; C.I. Solvent Yellow 19, 44, 77, 79, 81, 82, 93, 98, 103, 104, 112, 162; and C.I. Solvent Blue 25, 36, 69, 70, 93, 95.

For each color, it is possible to use one colorant, or a combination of two or more of the colorants for obtaining a toner of the color.

The content rate of the colorant relative to 100 parts by mass of the binder resin is preferably 1 to 20 parts by mass, and more preferably 4 to 15 parts by mass.

[Releasing Agent]

The releasing agent is not particularly limited, and various known waxes can be used. Examples of such waxes include: polyolefin waxes such as polyethylene wax and polypropylene wax; branched chain hydrocarbon-based waxes such as microcrystalline wax; long chain hydrocarbon-based waxes such as paraffin wax and Sasol wax; dialkyl ketone-based waxes such as distearyl ketone; ester-based waxes such as carnauba wax, montan wax, behenyl behenate, trimethylolpropane tribehenate, pentaerythritol tetrabehenate, pentaerythritol diacetate dibehenate, glycerin tribehenate, 1,18-octadecanediol distearate, tristearyl trimellitate, and distearyl maleate; and amide-based waxes such as ethylenediamine dibehenylamide and tristearyl trimellitate amide.

The content rate of the releasing agent relative to 100 parts by mass of the binder resin is normally 1 to 30 parts by mass, and more preferably 5 to 20 parts by mass. As the content rate of the releasing agent stays within the above range, sufficient post-fixing separability is achieved.

[Charge Control Agent]

The charge control agent may be any of various known compounds.

The content rate of the charge control agent relative to 100 parts by mass of the binder resin is normally 0.1 to 5.0 parts by mass.

[Softening Point of the Toner]

So as to cause the toner to have low-temperature fixing properties, the softening point of the toner is preferably 70 to 120° C., and more preferably 80 to 110° C.

The softening point of the toner is measured with the flow tester described below.

Specifically, 1.1 g of the sample (the toner) is first placed in a petri dish in an environment at 20° C. and 50% RH and is flattened out therein. After left for 12 hours or longer, the sample is pressed by a molding machine “SSP-10A” (manufactured by Shimadzu Corporation) at a pressure of 3,820 kg/cm² for 30 seconds, to form a cylindrical molded sample of 1 cm in diameter. The molded sample is then placed in a flow tester “CFT-500D” (manufactured by Shimadzu Corporation) in an environment at 24° C. and 50% RH. Under the conditions of a load of 196 N (20 kgf), a start temperature of 60° C., a preheating time of 300 seconds, and a temperature rising rate of 6° C./min, the molded sample is extruded from the hole (1 mm in diameter×1 mm) of a cylindrical die with the use of a piston of 1 cm in diameter after the end of preheating. An offset temperature T_{offset} measured by a melt temperature measurement method (a temperature raising method) with a predetermined offset value of 5 mm is set as the softening point.

[Mean Particle Size of the Toner]

The mean particle size of the toner of this embodiment of the present invention is preferably 3 to 9 μm in terms of a volume-based median diameter, for example, and more preferably 3 to 8 μm. In a case where the toner is manufactured by an emulsion aggregation method (described later), the particle size can be controlled by adjusting the concentration of the aggregating agent, the addition of an organic solvent, the fusing time, and the composition of the polymer.

As the volume-based median diameter of the toner stays within the above range, high transfer efficiency is achieved, and the quality of a halftone image is improved. Furthermore, the image quality of fine lines and dots is improved.

The volume-based median diameter of the toner is measured and calculated by using a measuring device formed by connecting a computer system having data processing software “Software V3.51” mounted thereon to “MULTISIZER 3” (manufactured by Beckman Coulter, Inc.). Specifically, 0.02 g of the toner is added to 20 mL of a surfactant solution (a surfactant solution that is designed for dispersing the toner particles and is formed by diluting ten-fold a neutral detergent containing a surfactant component with pure water) and is mixed therein, and ultrasonic dispersion is then performed for one minute, to prepare a dispersion of the toner. With a pipette, this toner dispersion is injected into a beaker that is held in a sample stand and contains “ISOTON II” (manufactured by Beckman Coulter, Inc.), until the concentration displayed on the measuring device reaches 8%. With this concentration range, a reproducible measured value can be obtained. In the measuring device, the measured particle number count is set to 25,000, and the aperture size is adjusted to 50 μm. The range of measurement (1 to 30 μm) is divided into 256 sections, and a frequency value in each section is calculated. The particle size measured when the cumulative volume fraction cumulated from the largest volume fraction is 50% is set as the volume-based median diameter.

[Mean Circularity of the Toner Particles]

So as to increase transfer efficiency, the mean circularity of the toner according to this embodiment of the present invention is preferably 0.930 to 1.000, and more preferably 0.940 to 0.995.

In the present invention, the mean circularity of the toner particles is measured with “FPIA-2100” (manufactured by Sysmex Corporation).

Specifically, the sample (the toner particles) is immersed in a surfactant-containing aqueous solution and is then subjected to ultrasonic dispersion treatment for one minute, to disperse the toner particles. Images of the toner are taken with “FPIA-2100” (manufactured by Sysmex Corporation) in HPF (high-power field) mode at an appropriate density of 3,000 to 10,000 in the number of particles detected in the HPF mode. The degrees of circularity of the respective toner particles are calculated according to the equation (T) shown below. The mean circularity of the toner is then determined by adding up the degrees of circularity of the respective toner particles, and dividing the total sum by the number of the toner particles.

circularity=(the circumference of a circle having the same projected area as the particle image)/(the circumference of a projected particle image) Equation (T):

[Toner Manufacturing Method]

Examples of methods of manufacturing the toner according to this embodiment of the present invention include a kneading-pulverizing method, a suspension polymerization method, an emulsion polymerization method, an emulsion aggregation method, an emulsion polymerization aggregation method, a miniemulsion polymerization aggregation method, an encapsulation method, and other known methods. It is particularly preferable to use the emulsion polymerization method for obtaining toner particles by aggregating and fusing fine particles of the resin that forms the binder resin.

According to the emulsion aggregation method, toner particles are manufactured by mixing a dispersion of fine particles of the resin forming the binder resin with a dispersion of fine particles of other components forming the toner particles as necessary, slowly aggregating the toner particles while keeping balance between the repulsive force of the fine particle surfaces due to pH adjustment and the cohesive force generated by an addition of an aggregating agent made of an electrolyte, controlling the mean particle size and the particle size distribution, and heating and stirring the mixture to fuse the fine particles and control the shapes of the fine particles.

[External Additives]

Although the above described toner particles can form the toner of this embodiment of the present invention without any external additives, it is possible to add external additives such as a superplasticizer and a cleaning aid that are so-called post-processing agents to the toner particles, so as to improve fluidity, charging properties, cleaning properties, and the like.

Examples of post-processing agents include: inorganic oxide fine particles formed with silica fine particles, alumina fine particles, titania fine particles, or the like; inorganic stearate compound fine particles such as aluminum stearate fine particles and zinc stearate fine particles; and inorganic titanate compound fine particles such as strontium titanate and zinc titanate. It is possible to use one of these materials or a combination of two or more of these materials.

So as to improve heat-resistant storage properties and environmental safety, those inorganic fine particles are preferably subjected to surface treatment with a silane coupling agent, a titanate coupling agent, a higher fatty acid, silicone oil, or the like.

A total of these external additives relative to 100 parts by mass of the toner is 0.05 to 5 parts by mass, and more preferably 0.1 to 3 parts by mass. It is also possible to use any combination of various external additives.

Since the toner of this embodiment of the present invention is formed with toner particles each having a core-shell structure that includes a core portion containing the first polyester resin A and a shell layer containing the second polyester resin B with a high meta-phenylene skeleton content rate, sufficient low-temperature fixing properties and excellent heat-resistant storage properties are achieved at the same time, and a fixed image with reduced glossiness can be formed.

[Developer]

The toner of this embodiment of the present invention can be used as a magnetic or non-magnetic single-component developer, but may also be mixed with a carrier and used as a two-component developer.

As for the carrier, it is possible to use magnetic particles made of known materials including metals such as ferrite and magnetite, and alloys of one of these metals and other metals such as aluminum and lead. Of these materials, it is particularly preferable to use ferrite particles. It is also possible to use a coated carrier formed by coating the surfaces of magnetic particles with a coating agent such as a resin, a resin-dispersed carrier formed by dispersing magnetic fine particles in a binder resin, or the like.

The volume mean particle size of the carrier is preferably 15 to 100 μm, and more preferably 25 to 80 μm.

[Image Forming Device]

The toner of this embodiment of the present invention can be used in conjunction with a conventional electrophotographic image forming method, and an image forming device that implements such an image forming method includes: a photosensitive member serving as an electrostatic latent image carrier; a charging unit that uniformly charges the surface of the photosensitive member through corona discharge of the same polarity as the toner; an exposing unit that forms an electrostatic latent image by performing image exposure onto the uniformly charged surface of the photosensitive member based on image data; a developing unit that forms a toner image by conveying the toner onto the surface of the photosensitive member and developing the electrostatic latent image; a transferring unit that transfers the toner image onto a transfer member via an intermediate transfer member as necessary; and a fixing unit that heats and fixes the toner image onto the transfer member.

The toner of this embodiment of the present invention can be suitably used at a relatively low fixing temperature (the surface temperature of the fixing member) of 100 to 200° C.

Although an embodiment of the present invention has been described in detail, embodiments of the present invention are not limited to the above example, and various changes may be made to it.

### EXAMPLES

Specific examples of the present invention are now described, but the present invention is not limited to these examples.

[Example of Preparation of an Aqueous Dispersion [1] of Styrene-Acrylic Resin Fine Particles]

### (First Stage of Polymerization)

A 1-liter reaction vessel equipped with a stirrer, a temperature sensor, a condenser tube, and a nitrogen introduction tube was charged with a solution formed by dissolving 1.5 parts by mass of sodium polyoxyethylene (2) dodecyl sulfate in 560 parts by mass of ion exchanged water. The inside of the reaction vessel was heated to 80° C. while the solution was stirred at a stirring rate of 300 rpm in a nitrogen gas flow. After the temperature rise, a solution formed by dissolving 1.9 parts by mass of potassium persulfate in 37 parts by mass of ion exchanged water was added, and the solution was again heated to 80° C. A monomer solution containing the compounds shown below was dripped for one hour, and was then heated and stirred at 90° C. for two hours, to cause polymerization.

Styrene: 113 parts by mass
n-Butylacrylate; 32 parts by mass
Methacrylic acid: 13.6 parts by mass
In this manner, a dispersion [a] of resin fine particles was prepared.

(Second Stage of Polymerization)

A 5-liter reaction vessel equipped with a stirrer, a temperature sensor, a condenser tube, and a nitrogen introduction tube was charged with a solution formed by dissolving 7.4 parts by mass of sodium polyoxyethylene (2) dodecyl ether sulfate in 970 parts by mass of ion exchanged water, and was heated to 98° C. A solution formed by dissolving a monomer solution containing the compounds shown below in 285 parts by mass of the dispersion [a] of resin fine particles at 90° C. was added to the reaction vessel.

Styrene: 284 parts by mass
n-Butylacrylate: 92 parts by mass
Methacrylic acid: 15.7 parts by mass
n-Octyl-3-mercapto propionate: 4.2 parts by mass
“HNP-0190” (manufactured by Nippon Seiro Co., Ltd.): 120 parts by mass

The mixture was mixed and dispersed for 1 hour with a mechanical disperser having a circulation path “CLEARMIX” (manufactured by M Technique Co., Ltd.), to prepare a dispersion containing emulsified particles (oil droplets).

An initiator solution formed by dissolving 6.6 parts by mass of potassium persulfate in 126 parts by mass of ion exchanged water was added to the obtained dispersion. The resultant dispersion was heated and stirred at a temperature of 84° C. for one hour, to cause polymerization. In this manner, a dispersion [b] of resin fine particles was prepared.

(Third Stage of Polymerization)

Further, a solution formed by dissolving 12 parts by mass of potassium persulfate in 290 parts by mass of ion exchanged water was added, and a monomer solution containing the compounds shown below was dripped for one hour at 82° C.

Styrene: 390 parts by mass
n-Butylacrylate: 180 parts by mass
Methacrylic acid: 30 parts by mass
n-Octyl-3-mercapto propionate: 8.6 parts by mass

After the dripping, the mixture was heated and stirred for two hours to cause polymerization, and was then cooled to 28° C. In this manner, an aqueous dispersion [1] of styrene-acrylic resin fine particles formed with a styrene-acrylic resin was obtained.

In the obtained aqueous dispersion [1] of styrene-acrylic resin fine particles, the glass transition point (Tg) of the styrene-acrylic resin fine particles was 50° C., the volume-based median diameter was 220 nm, and the weight-average molecular weight (Mw) was 59,500.

[Example of Preparation of an Aqueous Dispersion [C1] of Crystalline Polyester Resin Fine Particles]

### (1) Formation of a Crystalline Polyester Resin

A 5-liter reaction vessel equipped with a stirrer, a temperature sensor, a condenser tube, and a nitrogen introduction tube was charged with 300 parts by mass of a polyprotic carboxylic acid that was sebacic acid (molecular weight: 202.25) and 170 parts by mass of a polyhydric alcohol that was 1,6-hexanediol (molecular weight: 118.17). While this mixture was stirred, the inside of the reaction vessel was heated to 190° C. in one hour. After a uniformly stirred state was confirmed, 0.003 mass % of Ti(OBu)₄ relative to the amount of the polyprotic carboxylic acid was added as a catalyst to the mixture. After that, the inside of the reaction vessel was heated from 190° C. to 240° C. in six hours while water being generated is distilled. Further, a dehydrative condensation reaction was continued at 240° C. for six hours, to cause polymerization. As a result, a crystalline polyester resin [C1] was obtained.

The melting point (Tm) of this crystalline polyester resin [C1] was 66.8° C., and the number average molecular weight (Mn) was 6,300.

(2) Preparation of an Aqueous Dispersion of Crystalline Polyester Resin Fine Particles

While 30 parts by mass of the crystalline polyester resin [C1] was dissolved and remained in a dissolved state, the crystalline polyester resin [C1] was transported to an emulsion disperser “CAVITRON CD1010” (manufactured by Eurotec Co., Ltd.) at a transportation speed of 100 parts by mass per minute. At the same time as the transportation of the crystalline polyester resin [C1] in a dissolved state, diluted ammonia water of 0.37 mass % in density formed by diluting 70 parts by mass of reagent ammonia water with ion exchanged water in an aqueous solvent tank was transported to the emulsion disperser at a transportation speed of 0.1 liter per minute while being heated to 100° C. with a heat exchanger. The emulsion disperser was then operated with the rotor rotating at a rotational speed of 60 Hz and at a pressure of 5 kg/cm², to prepare an aqueous dispersion [C1] of crystalline polyester resin fine particles having a volume-based median diameter of 200 nm and 30 parts by mass of a solid component.

[Example of Preparation of an Aqueous Dispersion [A1] of Vinyl-Modified Polyester Resin Fine Particles]

### (1) Formation of a Vinyl-Modified Polyester Resin

A four-neck flask equipped with a nitrogen introduction tube, a dehydrating tube, a stirrer, and a thermocouple was charged with a solution containing the compounds shown below, to cause a polycondensation reaction at 230° C. for eight hours. Bisphenol A propylene oxide 2-mol adduct: 288 parts by mass

Isophthalic acid: 83 parts by mass
Trimellitic acid: 26 parts by mass
Fumaric acid: 14 parts by mass
Esterification catalyst (tin octylate): 1.5 parts by mass

A further reaction was caused at 8 kPa for one hour, and the mixture was cooled to 160° C. After that, a mixture of the components shown below was dripped with a drip funnel for one hour.

Acrylic acid: 5 parts by mass
Styrene: 75 parts by mass
Butylacrylate: 26 parts by mass
Polymerization initiator (di-t-butyl peroxide): 16 parts by mass

After the dripping, an addition polymerization reaction was continued for one hour while the temperature was maintained at 160° C. The temperature was then raised to 200° C., and the mixture was maintained at 10 kPa for one hour. After that, styrene and butylacrylate were removed, to obtain an amorphous vinyl-modified polyester resin [A1].

The glass transition point (Tg) of this vinyl-modified polyester resin [A1] was 56° C., the softening point (Tsp) was 100° C., and the weight-average molecular weight (Mw) was 12,300.

(2) Formation of Vinyl-Modified Polyester Resin Fine Particles

While 30 parts by mass of the obtained vinyl-modified polyester resin [A1] was dissolved and remained in a dissolved state, the vinyl-modified polyester resin [A1] was transported to an emulsion disperser “CAVITRON CD1010” (manufactured by Eurotec Co., Ltd.) at a transportation speed of 100 parts by mass per minute. At the same time as the transportation of the vinyl-modified polyester resin [A1] in a dissolved state, diluted ammonia water of 0.37 mass % in density formed by diluting 70 parts by mass of reagent ammonia water with ion exchanged water in an aqueous solvent tank was transported to the emulsion disperser at a transportation speed of 0.1 liter per minute while being heated to 100° C. with a heat exchanger. The emulsion disperser was then operated with the rotor rotating at a rotational speed of 60 Hz and at a pressure of 5 kg/cm², to prepare an aqueous dispersion [A1] of vinyl-modified polyester resin fine particles having a volume-based median diameter of 200 nm and 30 mass % of a solid component.

[Examples of Preparation of Aqueous Dispersions [A2] to [A6] of Vinyl-Modified Polyester Resin Fine Particles]

Aqueous dispersions [A2] to [A6] of vinyl-modified polyester resin fine particles formed with amorphous vinyl-modified polyester resins [A2] to [A6] were prepared in the same manner as in the example of preparation of the aqueous dispersion [A1] of vinyl-modified polyester resin fine particles, except for the aspects according to the formulas shown in Table 1.

TABLE 1

| | Polyhydric alcohol component | | | | | | | |
|---|---|---|---|---|---|---|---|---|
| | Bisphenol A | | | | | | | |
| | propylene | | Polyprotic carboxylic acid component | | | | Vinyl | Content of |
| PEs | oxide 2-mol | Meta-xylene | Isophthalic | Terephthalic | Trimellitic | Fumaric | polymerization | meta-phenylene |
| resin | adduct | glycol | acid | acid | acid | acid | segment | skeleton |
| Nos. | (mass %) | | | | | | | (mass %) |
| [A1] | 56 | 0 | 16 | 0 | 5.2 | 2.8 | 20 | 16 |
| [A2] | 56 | 0 | 8 | 8 | 5.2 | 2.8 | 20 | 8 |
| [A3] | 56 | 0 | 4 | 12 | 5.2 | 2.8 | 20 | 4 |
| [A4] | 56 | 0 | 1.5 | 14.5 | 5.2 | 2.8 | 20 | 1.5 |
| [A5] | 56 | 0 | 0 | 16 | 5.2 | 2.8 | 20 | 0 |
| [A6] | 40 | 16 | 0 | 16 | 5.2 | 2.8 | 20 | 16 |

*PEs resin = polyester resin

[Examples of Preparation of Aqueous Dispersions [A7] to [A10] of Amorphous Polyester Resin Fine Particles]

Aqueous dispersions [A7] to [A10] of amorphous polyester resin fine particles formed with amorphous polyester resins [A7] to [A10] were prepared in the same manner as in the example of preparation of the aqueous dispersion [C1] of crystalline polyester resin fine particles, except for the aspects according to the formulas shown in Table 2.

TABLE 2

| | Polyhydric alcohol component | | | | | | |
|---|---|---|---|---|---|---|---|
| | Bisphenol A | | | | | | |
| | propylene | | Polyprotic carboxylic acid component | | | | Content of |
| PEs | oxide 2-mol | Meta-xylene | Isophthalic | Terephthalic | Trimellitic | Fumaric | meta-phenylene |
| resin | adduct | glycol | acid | acid | acid | acid | skeleton |
| Nos. | (mass %) | | | | | | (mass %) |
| [A7] | 70 | 0 | 15.1 | 5 | 6.4 | 3.5 | 15.1 |
| [A8] | 70 | 0 | 10.1 | 10.1 | 6.4 | 3.5 | 10.1 |
| [A9] | 70 | 0 | 2 | 18.1 | 6.4 | 3.5 | 2 |
| [A10] | 70 | 0 | 0 | 20.1 | 6.4 | 3.5 | 0 |

[Example of Preparation of an Aqueous Dispersion [Bk] of Colorant Fine Particles]

First, 90 parts by mass of sodium dodecyl sulfate was added to 1600 parts by mass of ion exchanged water. While this solution was stirred, 420 parts by mass of carbon black “REGAL 330R” (manufactured by Cabot Corporation) was gradually added to the solution. The mixture was then subjected to dispersion treatment with the use of a stirring device “CLEARMIX” (manufactured by M Technique Co., Ltd.), to prepare an aqueous dispersion [Bk] of colorant fine particles.

In the obtained aqueous dispersion [Bk] of colorant fine particles, the volume-based median diameter of the colorant fine particles was 110 nm.

### Example 1

### Example Toner Manufacturing Process 1

### (Aggregation and Fusion Process)

A reaction vessel equipped with a stirrer, a temperature sensor, and a condenser tube was charged with 2000 parts by mass of ion exchanged water and the materials shown below as the resin fine particles for forming the core portion.

The aqueous dispersion [1] of styrene-acrylic resin fine particles (in terms of solid content): 288 parts by mass

The aqueous dispersion [C] of crystalline polyester resin fine particles (in terms of solid content): 32 parts by mass

After that, 5 mol/L of aqueous sodium hydroxide was added to the mixture, to adjust pH to 10. Further, 40 parts by pass of the aqueous dispersion [Bk] of colorant fine particles in terms of solid content was added to the mixture, and an aqueous solution formed by dissolving 60 parts by mass of magnesium chloride in 60 parts by mass of ion exchanged water was then added at 30° C. in ten minutes while being stirred.

After the mixture was left for three minutes, a temperature rise was started to heat the mixture to 80° C. in 60 minutes, and a particle growth reaction was continued while the temperature was maintained at 80° C. In this situation, the particle sizes in the aggregation were measured with “MULTISIZER 3” (manufactured by Beckman Coulter, Inc.). When the volume-based median diameter (D₅₀) reached 6.0 μm, 45 parts by mass of the aqueous dispersion [A] (in terms of solid content) of vinyl-modified polyester resin fine particles was added as the resin fine particles for forming the shell layer to the mixture in 30 minutes. When the supernatant of the reaction liquid became transparent, an aqueous solution formed by dissolving 105 parts by mass of sodium chloride in 420 parts by mass of ion exchanged water was added to the mixture, to stop particle growth. A temperature rise was further performed, and heating and stirring was performed at 90° C., to facilitate fusion between particles. When the mean circularity measured with a toner mean circularity measuring device “FPIA-2100” (manufactured by Sysmex Corporation) became 0.945 (with the number of HPF detections being 4,000), the mixture was cooled to 30° C., to prepare a dispersion of toner matrix particles [1].

(Washing and Drying Process)

The obtained dispersion of the toner matrix particles [1] was subjected to solid-liquid separation with a centrifugal separator, to form a wet cake of the toner matrix particles. The wet cake was washed with ion exchanged water at 35° C. in the centrifugal separator until the electric conductivity of the filtrate became 5 μS/cm. The wet cake was then moved to “FLASH JET DRYER” (manufactured by Seishin Enterprise Co. Ltd.), and was dried until the water content became 0.5 mass %. In this manner, the toner matrix particles [1] were obtained.

(External Additive Treatment Process)

To the toner matrix particles [1], 1 mass % of hydrophobic silica (number average primary particle size=12 nm) and 0.3 mass % of hydrophobic titania (number average primary particle size=20 nm) were added, and the mixture was mixed with a Henschel mixer, to manufacture the toner particles [1].

### Examples 2 to 11, Comparative Examples 1 to 7

Toners [2] to [18] were obtained in the same manner as in Example 1, except for the aspects according to the formulas shown in Table 3.

[Example Developer Manufacturing Processes 1 to 18]

A ferrite carrier that is coated with silicone resin and has a volume mean particle size of 60 μm was added to and mixed with each of the toners [1] to [18] so that the toner density became 6 mass %. In this manner, developers [1] to [18] were manufactured.

The above developers [1] to [18] were evaluated as follows.

(1) Low-Temperature Fixing Properties

In a copying machine “bizhub PRO C6500” (manufactured by Konica Minolta Business Technologies, Inc.), the fixing unit was modified to change the surface temperature (the fixing temperature) of the heating roller in the range of 120 to 200° C. With the use of this copying machine, a fixing experiment was repeatedly conducted, with the fixing temperature being increased by 5° C. from 120° C. to 200° C. In each experiment, a solid image with a toner adhesion quantity of 8.0 g/m² was fixed onto an A4 high-quality paper sheet “NPI 128 g/m²” (manufactured by Nippon Paper Industries Co., Ltd.) at room temperature and normal humidity (20° C. and 50% RH).

Of the fixing experiments that did not cause visually-recognizable smudges due to low-temperature offsetting, the fixing experiment that used the lowest fixing temperature was evaluated as having the lowest fixing temperature. The results are shown in Table 3. In the present invention, toners having lowest fixing temperatures of 160° C. or lower are regarded as acceptable.

(2) Heat-Resistant Storage Properties

For each of the toners [1] to [18], 0.5 g of a toner was placed in a 10-mL glass bottle having an inner diameter of 21 mm, and the bottle was closed, was shaken 600 times at room temperature with the use of a Tap Denser “KYT-2000” (manufactured by Seishin Enterprise Co., Ltd.) and was then left at 55° C. and 35% RH for 2 hours, with the bottle lid being removed. The toner was then placed on a 48-mesh sieve (sieve opening: 350 μm) in such a careful manner that the aggregates of the toner would not crack, and the sieve was set in a powder tester

(manufactured by Hosokawa Micron Corporation) and was secured by a presser bar and a knob nut. The vibration intensity of the powder tester was adjusted to a feed width of 1 mm, and the sieve was vibrated for 10 seconds to determine an amount of the toner remaining on the sieve. A toner aggregation rate that is a ratio of the amount of the remaining toner was then calculated according to the equation (1) shown below, and heat-resistant storage properties were evaluated based on the toner aggregation rate.

toner aggregation rate (mass %)={remaining toner (g)/0.5 (g)}×100 Equation (1):

A toner having a toner aggregation rate of 10 mass % or lower is determined to be excellent, a toner having a toner aggregation rate of 10 to 20 mass % is determined to be good, and a toner having a toner aggregation rate higher than 20 mass % is difficult to use in practice and is determined to be unacceptable. The results are shown in Table 3.

(3) Image Glossiness

A commercially available multifunction device “bizhub PRO C6500” (manufactured by Konica Minolta Business Technologies, Inc.) was used as the image forming device, and each developer was injected into the developing unit of this multifunction device. The surface temperature of the heating member of the fixing unit of a thermal roller fixing type was 180° C. A solid image with a toner quantity of 4.0 g/m² on a transfer paper sheet is transferred onto a transfer paper sheet “POD gloss coat (128 g/m²)” (manufactured by Oji Paper Co., Ltd.) at room temperature and normal humidity (20° C. and 50% RH). Glossiness of this solid image was measured at an incident angle of 75° with a glossmeter “Gloss Meter” (manufactured by Murakami Color Research Laboratory Co., Ltd.), with a glass surface of 1.567 in refractive index being the reference. Image glossiness was then evaluated. In the present invention, each toner having a degree of glossiness of 65% or lower is regarded as acceptable. The results are shown in Table 3.

TABLE 3

| | | Core resin | | | | | Shell resin | | | | | |
|---|---|---|---|---|---|---|---|---|---|---|---|---|
| | | StAc resin | | PEs resin | | | PEs resin | | | Evaluation results | | |
| | | | Addition | | Addition | | | Addition | | Lowest fixing | Toner | |
| | Toner | | (parts by | | (parts by | a | | (parts by | b | temperature | aggregation | |
| | Nos. | Nos. | mass) | Nos. | mass) | (mass %) | Nos. | mass) | (mass %) | (° C.) | rate (mass %) | Glossiness |
| Example 1 | 1 | [1] | 288 | [C1] | 32 | 0 | [A1] | 45 | 16 | 125 | 8 | 51 |
| Example 2 | 2 | [1] | 288 | [C1] | 32 | 0 | [A2] | 45 | 8 | 125 | 8 | 52 |
| Example 3 | 3 | [1] | 288 | [C1] | 32 | 0 | [A3] | 45 | 4 | 125 | 12 | 53 |
| Example 4 | 4 | [1] | 288 | [C1] | 32 | 0 | [A4] | 45 | 1.5 | 125 | 14 | 56 |
| Example 5 | 5 | [1] | 288 | [C1] | 32 | 0 | [A7] | 45 | 15.1 | 125 | 14 | 53 |
| Example 6 | 6 | [1] | 32 | [C1] | 288 | 0 | [A1] | 45 | 16 | 120 | 9 | 57 |
| Example 7 | 7 | [1] | 288 | [A9] | 32 | 2 | [A1] | 45 | 16 | 130 | 9 | 51 |
| Example 8 | 8 | [1] | 288 | [A7] | 32 | 15.1 | [A1] | 45 | 16 | 135 | 14 | 53 |
| Example 9 | 9 | — | — | [C1] | 320 | 0 | [A1] | 45 | 16 | 120 | 9 | 56 |
| Example 10 | 10 | — | — | [A9] | 320 | 2 | [A1] | 45 | 16 | 130 | 9 | 56 |
| Example 11 | 11 | [1] | 288 | [C1] | 32 | 0 | [A6] | 45 | 16 | 125 | 8 | 54 |
| Comparative | 12 | — | — | [A7] | 320 | 15.1 | [A10] | 45 | 0 | 165 | 25 | 66 |
| Example 1 | | | | | | | | | | | | |
| Comparative | 13 | [1] | 288 | [A7] | 32 | 15.1 | [A5] | 45 | 0 | 170 | 19 | 66 |
| Example 2 | | | | | | | | | | | | |
| Comparative | 14 | [1] | 288 | [A7] | 32 | 15.1 | [A2] | 45 | 8 | 170 | 17 | 61 |
| Example 3 | | | | | | | | | | | | |
| Comparative | 15 | [1] | 288 | [A8] | 32 | 10.1 | [A2] | 45 | 8 | 175 | 17 | 66 |
| Example 4 | | | | | | | | | | | | |
| Comparative | 16 | [1] | 288 | [C1] | 32 | 0 | [A5] | 45 | 0 | 155 | 26 | 67 |
| Example 5 | | | | | | | | | | | | |
| Comparative | 17 | [1] | 288 | [A9] | 32 | 2 | [A5] | 45 | 0 | 155 | 26 | 67 |
| Example 6 | | | | | | | | | | | | |
| Comparative | 18 | [1] | 288 | [A9] | 32 | 2 | [C1] | 45 | 0 | 155 | 30 | 66 |
| Example 7 | | | | | | | | | | | | |

Although the present invention has been described and illustrated in detail, it is clearly understood that the same is by way of illustrated and example only and is not to be taken by way of limitation, the scope of the present invention being interpreted by terms of the appended claims.

What is claimed is:

1. An electrostatic image developing toner comprising
a toner particle having a core-shell structure including a core portion containing a first polyester resin A, and a shell layer containing a second polyester resin B, the shell layer coating the core portion, wherein
the second polyester resin B has at least a meta-phenylene skeleton, and
the following relational expression (1) is satisfied:
0≦a<b relational expression (1):
where a represents a content rate (mass %) of a meta-phenylene skeleton in the first polyester resin A, and b represents a content rate (mass %) of the meta-phenylene skeleton in the second polyester resin B.

2. The electrostatic image developing toner according to claim 1, wherein the first polyester resin A contained in the core portion is a crystalline polyester resin.

3. The electrostatic image developing toner according to claim 1, wherein the second polyester resin B contained in the shell layer is an amorphous polyester resin.

4. The electrostatic image developing toner according to claim 1, wherein the meta-phenylene skeleton in the first polyester resin A contained in the core portion is derived from isophthalic acid.

5. The electrostatic image developing toner according to claim 1, wherein the meta-phenylene skeleton in the second polyester resin B contained in the shell layer is derived from isophthalic acid.

6. The electrostatic image developing toner according to claim 1, wherein a difference (b−a) between the content rate a of the meta-phenylene skeleton in the first polyester resin A contained in the core portion and the content rate b of the meta-phenylene skeleton in the second polyester resin B contained in the shell layer is 4 mass % or higher.

7. The electrostatic image developing toner according to claim 1, wherein the content rate b of the meta-phenylene skeleton in the second polyester resin B contained in the shell layer is 4 to 16 mass %.

8. The electrostatic image developing toner according to claim 7, wherein the content rate b of the meta-phenylene skeleton in the second polyester resin B contained in the shell layer is 8 to 16 mass %.

9. The electrostatic image developing toner according to claim 1, wherein the second polyester resin B contained in the shell layer is an amorphous polyester resin formed with a vinyl polymerization segment and a polyester polymerization segment being bound to each other.

10. The electrostatic image developing toner according to claim 1, wherein the core portion contains a styrene-acrylic resin as well as the first polyester resin A.

11. The electrostatic image developing toner according to claim 1, wherein a content rate of a vinyl polymerization segment in the second polyester resin B contained in the shell layer 5 to 30 mass % in the second polyester resin B.

12. The electrostatic image developing toner according to claim 1, wherein a content rate of the first polyester resin A contained in the core portion is 10 to 30 mass % in a core resin.

13. The electrostatic image developing toner according to claim 1, wherein a content rate of the second polyester resin B contained in the shell layer is 70 to 100 mass % in a shell resin.
